(19) United States
(12) Patent Application Publication
(10) Pub. No.: US 2022/0397652 A1
(43) Pub. Date: Dec. 15, 2022

(54) DISTANCE MEASURING SENSOR, DISTANCE MEASURING SYSTEM, AND ELECTRONIC EQUIPMENT

(71) Applicant: SONY SEMICONDUCTOR SOLUTIONS CORPORATION, KANAGAWA (JP)

(72) Inventor: KUMIKO MAHARA, KANAGAWA (JP)

(21) Appl. No.: 17/778,367

(22) PCT Filed: Nov. 13, 2020
(86) PCT No.: PCT/JP2020/042403

§ 371 Date: May 19, 2022

(30) Foreign Application Priority Data
Nov. 29, 2019 (JP) 2019-216558

(51) Int. Cl. G01S 7/497; G01S 17/10; G01S 7/4865

(52) U.S. Cl. CPC G01S 7/497; G01S 17/10; G01S 7/4865

(57) ABSTRACT

The present technology relates to a distance measuring sensor, a distance measuring system, and electronic equipment that can quickly cope with an error of an illumination device. A distance measuring sensor includes a pixel array section in which pixels that receive reflected light returned after irradiation light applied from an illumination device is reflected by an object and that output detection signals according to the amount of received light are two dimensionally arranged, and a control unit that detects occurrence of an error of the illumination device and performs control according to the error. The present technology can be applied to, for example, a distance measuring system and the like for measuring a distance to a subject.

### TECHNICAL FIELD

The present technology relates to a distance measuring sensor, a distance measuring system, and electronic equipment, and particularly to a distance measuring sensor, a distance measuring system, and electronic equipment that can quickly cope with an error of an illumination device.

### BACKGROUND ART

In distance measuring of a ToF (Time of Flight) method, irradiation light is emitted to an object from an illumination device having a light emission source such as an infrared laser diode, and reflected light returned after the irradiation light is reflected by the surface of the object is detected by a distance measuring sensor. Then, a distance to the object is calculated on the basis of the time of flight from the emission of the irradiation light to the reception of the reflected light.

As a method of coping with a case where an error occurs in an illumination device that emits irradiation light, there is a method in which the illumination device notifies a higher-level control unit controlling a distance measuring sensor and the illumination device of the occurrence of the error, and the higher-level control unit stops the light reception operation of the distance measuring sensor as described in, for example, PTL 1.

### CITATION LIST

### Patent Literature

[PTL 1]
Japanese Patent Laid-open No. 2019-41201

### SUMMARY

### Technical Problem

As disclosed in PTL 1, in the method in which the higher-level control unit stops the operation of the distance measuring sensor when an error occurs in the illumination device, a certain amount of time is required for stopping and restarting the distance measuring sensor.

The present technology has been developed in view of such a situation, and is intended to be able to quickly cope with an error of an illumination device.

### Solution to Problem

According to a first aspect of the present technology, a distance measuring sensor includes a pixel array section in which pixels that receive reflected light returned after irradiation light applied from an illumination device is reflected by an object and that output detection signals according to an amount of received light are two dimensionally arranged, and a control unit that detects occurrence of an error of the illumination device and performs control according to the error.

According to a second aspect of the present technology, a distance measuring system includes an illumination device that irradiates an object with irradiation light, and a distance measuring sensor that receives reflected light returned after the irradiation light is reflected by the object. The distance measuring sensor includes a pixel array section in which pixels outputting detection signals according to an amount of the received reflected light are two dimensionally arranged, and a control unit that detects occurrence of an error of the illumination device and performs control according to the error.

According to a third aspect of the present technology, electronic equipment includes a distance measuring system. The distance measuring system includes an illumination device that irradiates an object with irradiation light, and a distance measuring sensor that receives reflected light returned after the irradiation light is reflected by the object. The distance measuring sensor includes a pixel array section in which pixels outputting detection signals according to an amount of the received reflected light are two dimensionally arranged, and a control unit that detects occurrence of an error of the illumination device and performs control according to the error.

According to the first to third aspects of the present technology, the pixel array section which receives the reflected light returned after the irradiation light applied from the illumination device is reflected by the object and in which the pixels outputting the detection signals according to the amount of received light are two dimensionally arranged is provided, and the occurrence of the error of the illumination device is detected to perform control according to the error.

The distance measuring sensor, the distance measuring system, and the electronic equipment may be independent devices, or modules incorporated into other devices.

### BRIEF DESCRIPTION OF DRAWINGS

FIG. 1 is a block diagram depicting a configuration example of a distance measuring system to which the present technology is applied.

FIG. 2 is a diagram explaining the distance measuring principle of an indirect ToF method.

FIG. 3 is a diagram explaining the distance measuring principle of the indirect ToF method.

FIG. 4 is a block diagram depicting a detailed configuration example of an illumination device and a distance measuring sensor.

FIG. 5 is a diagram explaining LD error control of the distance measuring sensor.

FIG. 6 is a flowchart explaining a first LD error control process.

FIG. 7 is a flowchart explaining a second LD error control process.

FIG. 8 is a flowchart explaining a third LD error control process.

FIG. 9 is a diagram depicting an example of a table of type information of LD errors.

FIG. 10 is a flowchart explaining a fourth LD error control process.

FIG. 11 is a perspective view depicting a chip configuration example of the distance measuring sensor.

FIG. 12 is a block diagram of a distance measuring system for performing another light emission control method as a comparison example.

FIG. 13 is a block diagram depicting a configuration example of electronic equipment to which the present technology is applied.

FIG. 14 is a block diagram depicting an example of schematic configuration of a vehicle control system.

FIG. 15 is a diagram of assistance in explaining an example of installation positions of an outside-vehicle information detecting section and an imaging section.

### DESCRIPTION OF EMBODIMENT

Hereinafter, a mode for carrying out the present technology (hereinafter, referred to as an embodiment) will be described with reference to the accompanying drawings. It should be noted that in the specification and the drawings, constitutional elements having substantially the same functional configurations will be denoted by the same reference signs, and duplicate explanations thereof will be omitted. The explanation will be given in the following order.

1. Schematic configuration example of distance measuring system

2. Distance measuring principle of indirect ToF method

3. Configuration example of distance measuring sensor and illumination device

4. LD error control of distance measuring sensor

5. Flowchart of LD error control process

6. Chip configuration example of distance measuring sensor

7. Comparison with another light emission control method

8. Example of application to electronic equipment

9. Example of application to mobile body

### <1. Schematic Configuration Example of Distance Measuring System>

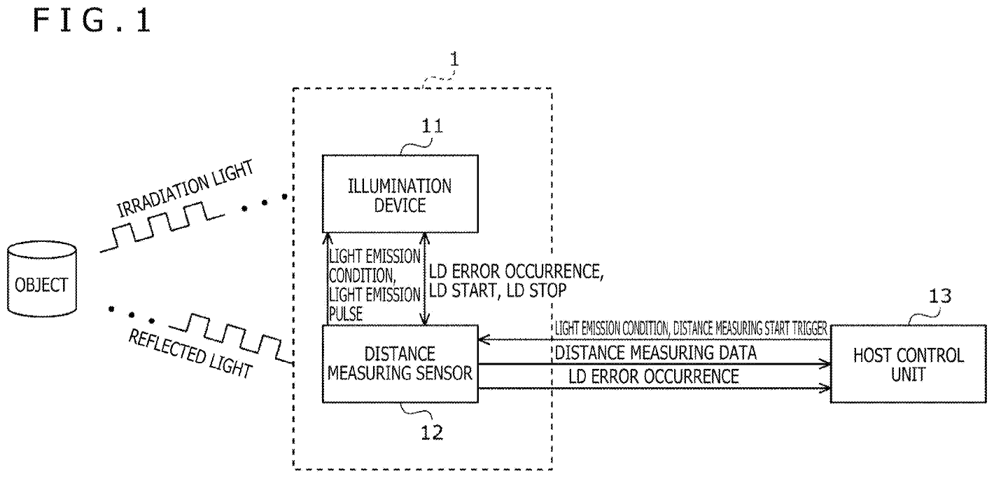

FIG. 1 is a block diagram depicting a configuration example of a distance measuring system to which the present technology is applied.

A distance measuring system 1 includes an illumination device 11 and a distance measuring sensor 12, measures a distance to a predetermined object as a subject according to an instruction from a host control unit 13 that is a control unit of a host device in which the distance measuring system 1 is incorporated, and outputs distance measuring data to the host control unit 13.

More specifically, the illumination device 11 has, for example, an infrared laser diode or the like as a light source, and irradiates the predetermined object as the subject with irradiation light on the basis of light emission pulses and light emission conditions supplied from the distance measuring sensor 12. The light emission pulses are pulse signals having a predetermined modulation frequency (for example, 20 MHz or the like) indicating the timing of light emission (ON/OFF), and the light emission conditions include, for example, light source setting information such as light emission intensity, an irradiation area, and an irradiation method. The illumination device 11 modulates and emits light, according to the light emission pulse, under the light emission conditions supplied from the distance measuring sensor 12.

In a case where an error occurs, the illumination device 11 notifies the distance measuring sensor 12 of LD error occurrence indicating the occurrence of the error, and stops and restarts according to a stop command and a start command (restart command) from the distance measuring sensor 12.

The distance measuring sensor 12 acquires a distance measuring start trigger indicating the start of distance measuring and the light emission conditions from the host control unit 13, supplies the acquired light emission conditions to the illumination device 11, generates a light emission pulse, supplies the same to the illumination device 11, and controls the light emission of the illumination device 11.

In addition, the distance measuring sensor 12 receives reflected light returned after the irradiation light applied from the illumination device 11 is reflected by the object, on the basis of the generated light emission pulse, generates distance measuring data on the basis of the light reception result, and outputs the data to the host control unit 13.

Further, in a case where the LD error occurrence is notified from the illumination device 11, the distance measuring sensor 12 performs control to stop or restart the illumination device 11. In addition, for example, in a case where an error (unrecoverable error) that cannot be recovered by restart is expected, the distance measuring sensor 12 outputs the LD error occurrence to the host control unit 13.

The host control unit 13 controls the entire host device in which the distance measuring system 1 is incorporated, and supplies, to the distance measuring sensor 12, the light emission conditions applied when the illumination device 11 applies irradiation light and the distance measuring start trigger indicating the start of distance measuring. The distance measuring data is supplied from the distance measuring sensor 12 in response to the distance measuring start trigger. The host control unit 13 includes, for example, an arithmetic device such as a CPU (central processing unit), an MPU (microprocessor unit), or an FPGA (field-programmable gate array) mounted on the host device, or an application program operating on the arithmetic device. In addition, for example, in a case where the host device includes a smartphone, the host control unit 13 includes an AP (application processor) or an application program operating thereon.

The distance measuring system 1 configured as described above uses a predetermined distance measuring method such as an indirect ToF (Time of Flight) method, a direct ToF method, and a structured light method, and performs distance measuring on the basis of the light reception result of the reflected light. The indirect ToF method is a method that detects the time of flight from the emission of the irradiation light to the reception of the reflected light as a phase difference and calculates the distance to the object. The direct ToF method is a method that directly measures the time of flight from the emission of the irradiation light to the reception of the reflected light and calculates the distance to the object. The structured light method is a method that irradiates the object with pattern light as irradiation light and calculates the distance to the object on the basis of the distortion of the pattern to be received.

The distance measuring method executed by the distance measuring system 1 is not limited to any particular method, but a concrete operation of the distance measuring system 1 will be described below by using an example of a case in which the distance measuring system 1 performs distance measuring by the indirect ToF method.

### <2. Distance Measuring Principle of Indirect ToF Method>

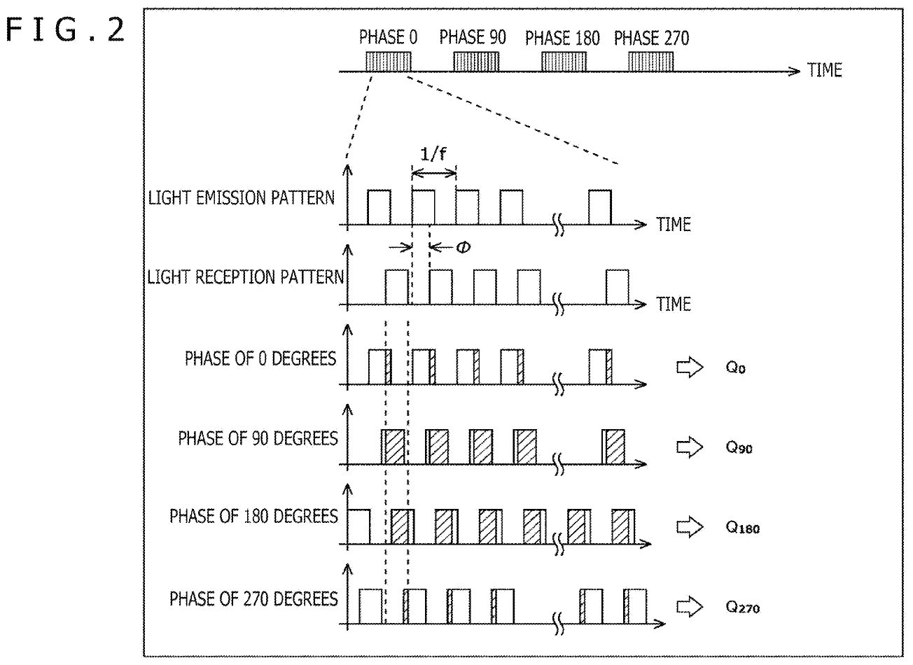

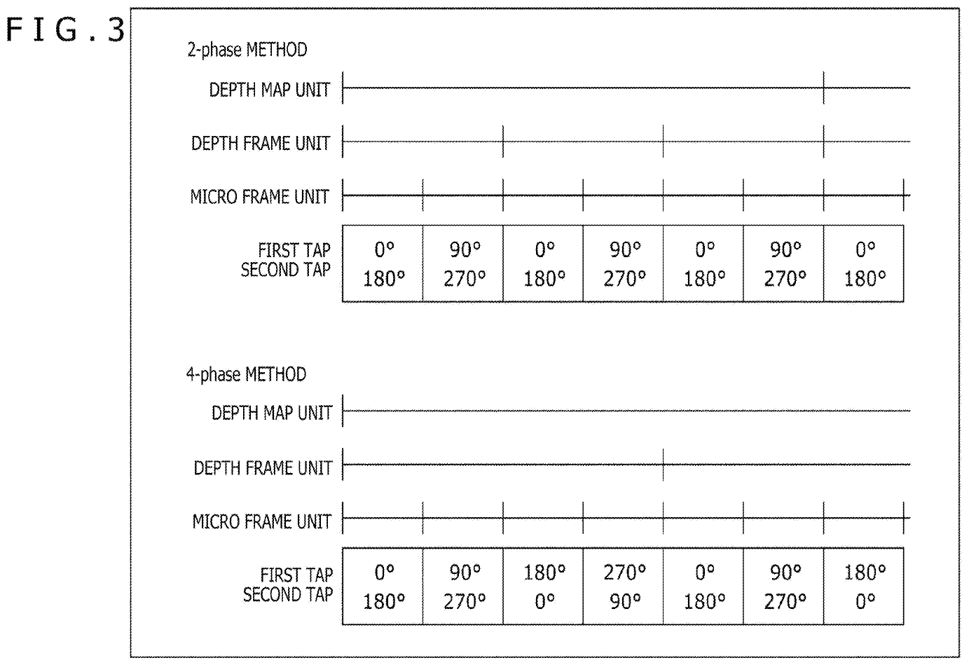

First, the distance measuring principle of the indirect ToF method will be briefly described with reference to FIG. 2 and FIG. 3.

A depth value d [mm] corresponding to the distance from the distance measuring system 1 to the object can be calculated by the following equation (1).

$$\begin{matrix}[ Math . 1 ] & \\ d = \frac{1}{2} \cdot c \cdot Δ t & ( 1 )\end{matrix}$$

In the equation (1), Δt is the time required until the irradiation light emitted from the illumination device 11 is reflected by the object and enters the distance measuring sensor 12, and c represents the speed of light.

As the irradiation light applied from the illumination device 11, pulse light having a light emission pattern that repeats ON/OFF at a predetermined modulation frequency f at a high speed as depicted in FIG. 2 is employed. One cycle T of the light emission pattern is 1/f. In the distance measuring sensor 12, the phase of the reflected light (light reception pattern) is shifted and detected according to the time Δt required for the light to reach the distance measuring sensor 12 from the illumination device 11. When the amount of phase shift (phase difference) between the light emission pattern and the light reception pattern is φ, the time Δt can be calculated by the following equation (2).

$$\begin{matrix}[ Math . 2 ] & \\ Δ t = \frac{1}{f} \cdot \frac{ϕ}{2 π} & ( 2 )\end{matrix}$$

Therefore, the depth value d from the distance measuring system 1 to the object can be calculated by the following equation (3) on the basis of the equation (1) and the equation (2).

$$\begin{matrix}[ Math . 3 ] & \\ d = \frac{c ϕ}{4 π f} & ( 3 )\end{matrix}$$

Next, a method of calculating the above-described phase difference φ will be described.

Each pixel of a pixel array formed in the distance measuring sensor 12 repeats ON/OFF at a high speed according to the modulation frequency, and accumulates electric charges only during the ON period.

The distance measuring sensor 12 sequentially switches the ON/OFF execution timing of each pixel of the pixel array, accumulates electric charges at each execution timing, and outputs a detection signal according to the accumulated electric charges.

There are four types of ON/OFF execution timings, that is, a phase of 0 degrees, a phase of 90 degrees, a phase of 180 degrees, and a phase of 270 degrees, for example.

The execution timing of the phase of 0 degrees is a timing for setting the ON timing (light reception timing) of each pixel of the pixel array to the phase of the pulse light emitted by the illumination device 11, that is, the phase same as the light emission pattern.

The execution timing of the phase of 90 degrees is a timing for setting the ON timing (light reception timing) of each pixel of the pixel array to a phase delayed by 90 degrees from the pulse light (light emission pattern) emitted by the illumination device 11.

The execution timing of the phase of 180 degrees is a timing for setting the ON timing (light reception timing) of each pixel of the pixel array to a phase delayed by 180 degrees from the pulse light (light emission pattern) emitted by the illumination device 11.

The execution timing of the phase of 270 degrees is a timing for setting the ON timing (light reception timing) of each pixel of the pixel array to a phase delayed by 270 degrees from the pulse light (light emission pattern) emitted by the illumination device 11.

The distance measuring sensor 12 sequentially switches the light reception timing in the order of, for example, the phase of 0 degrees, the phase of 90 degrees, the phase of 180 degrees, and the phase of 270 degrees, and acquires the light reception amount (accumulated electric charges) of the reflected light at each light reception timing. In FIG. 2, at the light reception timing (ON timing) of each phase, diagonal lines are added to the timing at which the reflected light enters.

As depicted in FIG. 2, if the electric charges accumulated when the light reception timings are set to the phase of 0 degrees, the phase of 90 degrees, the phase of 180 degrees, and the phase of 270 degrees are Q₀, Q₉₀, Q₁₈₀, and Q₂₇₀, respectively, the phase difference φ can be calculated by the following equation (4) using Q₀, Q₉₀, Q₁₈₀, and Q₂₇₀.

$$\begin{matrix}[ Math . 4 ] & \\ ϕ = Arctan \frac{{Q}_{90} - {Q}_{270}}{{Q}_{180} - {Q}_{0}} & ( 4 )\end{matrix}$$

By inputting the phase difference φ calculated by the equation (4) into the above equation (3), the depth value d from the distance measuring system 1 to the object can be calculated.

In addition, a confidence conf is a value representing the intensity of the light received by each pixel, and can be calculated, for example, by the following equation (5).

[Math. 5]

conf=\sqrt{(Q₁₈₀−Q₀)²+(Q₉₀−Q₂₇₀)²} (5)

The distance measuring sensor 12 calculates the depth value d that is the distance from the distance measuring system 1 to the object, on the basis of a detection signal supplied for each pixel of the pixel array. Then, a depth map in which the depth value d is stored as the pixel value of each pixel and a confidence map in which the confidence conf is stored as the pixel value of each pixel are generated and output to the outside.

As the pixel configuration of the distance measuring sensor 12, for example, a configuration in which each pixel of the pixel array is provided with two electric charge accumulation sections is employed. When it is assumed that the two electric charge accumulation sections are referred to as a first tap and a second tap, by alternately accumulating electric charges in the two electric charge accumulation sections of the first tap and the second tap, for example, detection signals having inverted phases at two light reception timings such as the phase of 0 degrees and the phase of 180 degrees can be acquired in one frame.

Here, the distance measuring sensor 12 generates and outputs the depth map and the confidence map by either a 2-phase method or a 4-phase method.

The upper part of FIG. 3 depicts generation of a depth map of the 2-phase method.

In the 2-phase method, as depicted in the upper part of FIG. 3, since the detection signals of four phases can be acquired by acquiring the detection signals of the phase of 0 degrees and the phase of 180 degrees in the first frame and acquiring the detection signals of the phase of 90 degrees and the phase of 270 degrees in the next second frame, the depth value d can be calculated by the equation (3).

In the 2-phase method, when a unit (one frame) for generating the detection signals of the phase of 0 degrees and the phase of 180 degrees or the phase of 90 degrees and the phase of 270 degrees are referred to as a micro frame, data of four phases are aligned in two micro frames, so that the depth value d can be calculated in pixel units by using the data of the two micro frames. When a frame in which the depth value d is stored as the pixel value of each pixel is referred to as a depth frame, one depth frame includes two micro frames.

Further, the distance measuring sensor 12 acquires a plurality of depth frames by changing light emission conditions such as the light emission intensity and the modulation frequency, and generates a final depth map by using the plurality of depth frames. That is, one depth map is generated using a plurality of depth frames. In the example of FIG. 3, a depth map is generated using three depth frames. It should be noted that one depth frame may be output as a depth map as it is. That is, one depth map can include one depth frame.

The lower part of FIG. 3 depicts generation of a depth map of the 4-phase method.

In the 4-phase method, as depicted in the lower part of FIG. 3, the detection signals of the phase of 180 degrees and the phase of 0 degrees are acquired in the third frame following the first frame and the second frame, and the detection signals of the phase of 270 degrees and the phase of 90 degrees are acquired in the next fourth frame. That is, the detection signals of all the four phases of the phase of 0 degrees, the phase of 90 degrees, the phase of 180 degrees, and the phase of 270 degrees are acquired in each of the first tap and the second tap, and the depth value d is calculated by the equation (3). Therefore, in the 4-phase method, one depth frame includes four micro frames, and one depth map is generated by using a plurality of depth frames in which the light emission conditions are changed.

Since the detection signals of all the four phases can be acquired in each tap (the first tap and the second tap) in the 4-phase method, characteristic variations between the taps existing in each pixel, that is, a sensitivity difference between the taps can be eliminated.

On the other hand, since the depth value d up to the object can be obtained by the data of two micro frames in the 2-phase method, the distance measuring can be performed at a frame rate twice that of the 4-phase method. The characteristic variations between the taps are adjusted by correction parameters such as gain and offset.

The distance measuring sensor 12 can be driven by either the 2-phase method or the 4-phase method, but the embodiment will be described below on the assumption that the distance measuring sensor 12 is driven by the 4-phase method.

### <3. Configuration Example of Distance Measuring Sensor and Illumination Device>

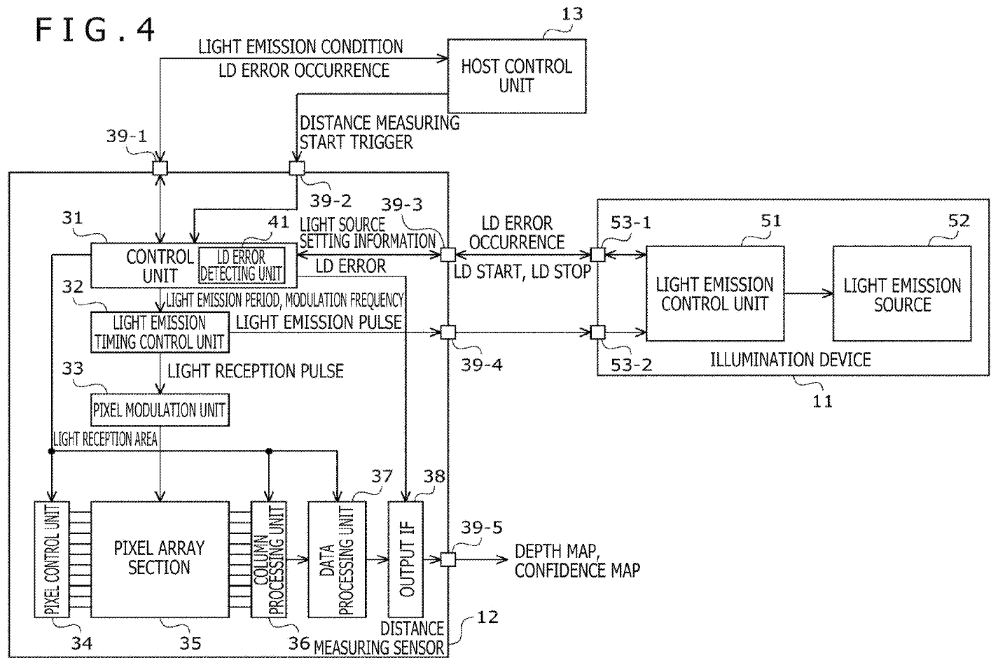

FIG. 4 is a block diagram depicting a detailed configuration example of the illumination device 11 and the distance measuring sensor 12. It should be noted that the host control unit 13 is also illustrated in FIG. 4 in order to facilitate understanding.

The distance measuring sensor 12 includes a control unit 31, a light emission timing control unit 32, a pixel modulation unit 33, a pixel control unit 34, a pixel array section 35, a column processing unit 36, a data processing unit 37, an output IF 38, and input/output terminals 39-1 to 39-5.

The illumination device 11 includes a light emission control unit 51, a light emission source 52, and input/output terminals 53-1 and 53-2.

The light emission conditions are supplied from the host control unit 13 to the control unit 31 of the distance measuring sensor 12 via the input/output terminal 39-1, and the distance measuring start trigger is supplied via the input/output terminal 39-2. The control unit 31 controls the operation of the entire distance measuring sensor 12 and the illumination device 11 on the basis of the light emission conditions and the distance measuring start trigger.

More specifically, on the basis of the light emission conditions supplied from the host control unit 13, the control unit 31 supplies information such as the light emission intensity, the irradiation area, and the irradiation method that are part of the light emission conditions to the illumination device 11 as light source setting information via the input/output terminal 39-3. The light emission intensity represents the intensity (the amount of light) of the irradiation light to be emitted. The irradiation area includes entire surface irradiation for irradiating the entire area and partial irradiation for irradiating only part of the entire area, and the irradiation method includes a surface irradiation method for irradiating the entire area with light at substantially uniform light emission intensity and a spot irradiation method for irradiating the area with light of a plurality of spots (circles) arranged at predetermined intervals.

In addition, on the basis of the light emission conditions supplied from the host control unit 13, the control unit 31 supplies information of the light emission period and the modulation frequency that are part of the light emission conditions to the light emission timing control unit 32. The light emission period represents an integration period per micro frame.

Further, the control unit 31 supplies drive control information including the light reception area of the pixel array section 35 to the pixel control unit 34, the column processing unit 36, and the data processing unit 37, according to the irradiation area and the irradiation method supplied to the illumination device 11.

The control unit 31 has an LD error detecting unit 41 as part of the function. The LD error detecting unit 41 detects the occurrence of an error of the illumination device 11 and performs control according to the error.

Specifically, in a case where the LD error occurrence indicating that an error has occurred is supplied from the light emission control unit 51 of the illumination device 11 via the input/output terminal 39-3, the LD error detecting unit 41 controls the light emission timing control unit 32 to stop the output of a light emission pulse or controls the output IF 38 to output the distance measuring data, which is to be output, with an error flag added thereto. In addition, the LD error detecting unit 41 controls the stop (LD stop) or restart (LD start) of the illumination device 11.

The light emission timing control unit 32 generates a light emission pulse on the basis of the information of the light emission period and the modulation frequency supplied from the control unit 31, and supplies the same to the illumination device 11 via the input/output terminal 39-4. The light emission pulse becomes a pulse signal having the modulation frequency supplied from the control unit 31, and the integration time of the High period in one micro frame of the light emission pulse becomes the light emission period supplied from the control unit 31. The light emission pulse is supplied to the illumination device 11 via the input/output terminal 39-4 at a timing according to the distance measuring start trigger from the host control unit 13.

In addition, the light emission timing control unit 32 generates a light reception pulse for receiving the reflected light in synchronization with the light emission pulse, and supplies the same to the pixel modulation unit 33. As described above, the light reception pulse becomes a pulse signal delayed only by any phase of the phase of 0 degrees, the phase of 90 degrees, the phase of 180 degrees, or the phase of 270 degrees with respect to the light emission pulse.

The pixel modulation unit 33 switches an electric charge accumulation operation to the first tap and the second tap of each pixel of the pixel array section 35 on the basis of the light reception pulse supplied from the light emission timing control unit 32.

On the basis of the drive control information supplied from the control unit 31, the pixel control unit 34 controls the reset operation, the read operation, or the like of the accumulated electric charges of each pixel of the pixel array section 35. For example, the pixel control unit 34 can perform partial drive of driving only part of a light reception region corresponding to all the pixels, according to a light reception area supplied from the control unit 31 as part of the drive control information. In addition, for example, the pixel control unit 34 can also perform control such as thinning out the detection signals of the pixels in the light reception area at predetermined intervals and adding the detection signals of the plurality of pixels (pixel addition).

The pixel array section 35 includes a plurality of pixels two-dimensionally arranged in a matrix. Each pixel of the pixel array section 35 receives reflected light under the control of the pixel modulation unit 33 and the pixel control unit 34, and supplies a detection signal according to the amount of received light to the column processing unit 36.

The column processing unit 36 includes a plurality of AD (Analog to Digital) conversion units, and the AD conversion unit provided for each pixel column of the pixel array section 35 performs a noise removal process and an AD conversion process for the detection signal output from a predetermined pixel of the corresponding pixel column. The detection signal having undergone the AD conversion process is supplied to the data processing unit 37.

The data processing unit 37 calculates the depth value d of each pixel on the basis of the detection signal of each pixel, the detection signal having undergone the AD conversion and being supplied from the column processing unit 36, and generates a depth frame in which the depth value d is stored as the pixel value of each pixel. Further, the data processing unit 37 generates a depth map by using one or more depth frames. In addition, the data processing unit 37 calculates the confidence conf on the basis of the detection signal of each pixel, and also generates a confidence frame corresponding to the depth frame in which the confidence conf is stored as the pixel value of each pixel, and a confidence map corresponding to the depth map. The data processing unit 37 supplies the generated depth map and confidence map to the output IF 38.

The output IF 38 converts the depth map and the confidence map supplied from the data processing unit 37 into the signal format (for example, MIPI: Mobile Industry Processor Interface) of the input/output terminal 39-5, and outputs the converted format from the input/output terminal 39-5. The depth map and the confidence map output from the input/output terminal 39-5 are supplied to the host control unit 13 as distance measuring data. It should be noted that the output IF 38 may supply the units of the depth frame and the confidence frame to the host control unit 13 as distance measuring data. It is sufficient if the distance measuring data is data of a frame in which the depth value d to the object is stored as a pixel value.

In FIG. 4, the input/output terminals 39-1 to 39-5 and the input/output terminals 53-1 and 53-2 are divided into a plurality of portions for convenience of explanation, but may be configured as one terminal (terminal group) having a plurality of input/output contacts. In addition, it is also possible to set the light emission conditions and the light source setting information by using a serial communication such as an SPI (Serial Peripheral Interface) or an I2C (Inter-Integrated Circuit). In a case where the serial communication of the SPI or the I2C is used, the distance measuring sensor 12 operates as a master side, and can set the light source setting information to the illumination device 11 at a freely-selected timing. By using the serial communication such as the SPI and the I2C, complicated and detailed settings can be performed using registers.

The light emission control unit 51 of the illumination device 11 includes a laser driver or the like, and drives the light emission source 52 on the basis of the light source setting information and the light emission pulse supplied from the distance measuring sensor 12 via the input/output terminals 53-1 and 53-2.

The light emission source 52 includes, for example, one or more laser light sources such as a VCSEL (Vertical Cavity Surface Emitting Laser). The light emission source 52 emits irradiation light at a predetermined light emission intensity, a predetermined irradiation area, a predetermined irradiation method, a predetermined modulation frequency, and a predetermined light emission period, according to the drive control of the light emission control unit 51.

A temperature sensor that is not illustrated is provided near the light emission source 52, and the light source temperature detected by the temperature sensor is supplied to the light emission control unit 51. The light emission control unit 51 can periodically output the light source temperature from the temperature sensor to the control unit 31 of the distance measuring sensor 12 via the input/output terminal 53-1 and the input/output terminal 39-3.

In the distance measuring sensor 12 configured as described above, the control unit 31 controls the operation of the entire distance measuring sensor 12, and controls the light emission operation of the illumination device 11 according to the operation state of the entire distance measuring sensor 12. In addition, in a case where an error occurs in the illumination device 11, the distance measuring sensor 12 detects the occurrence of the error of the illumination device 11 and performs control according to the error.

### <4. LD Error Control of Distance Measuring Sensor>

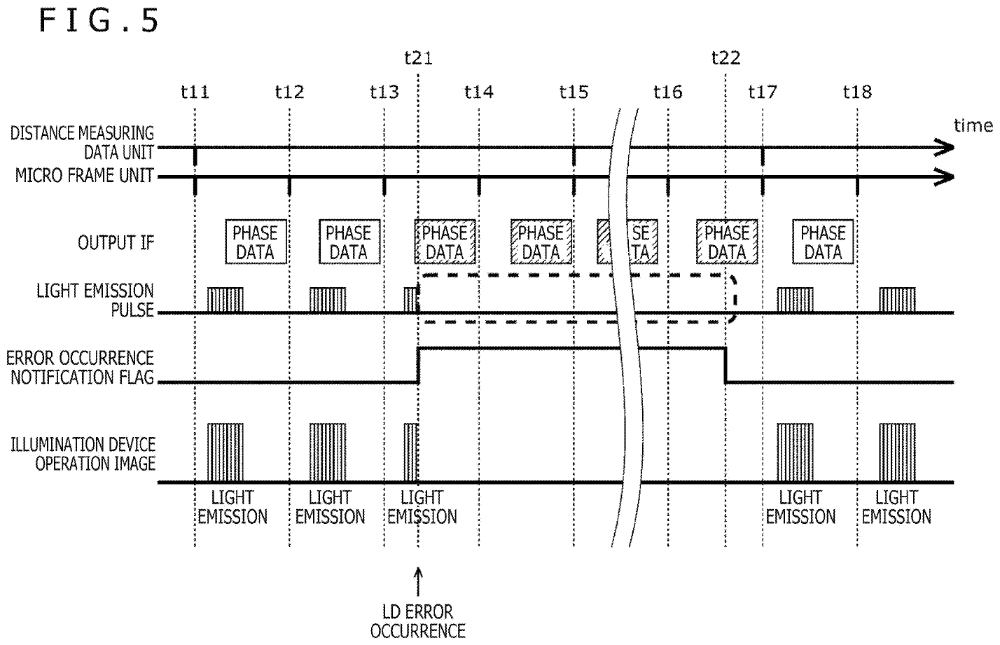

With reference to FIG. 5, LD error control of the distance measuring sensor 12 in a case where an error occurs in the illumination device 11 will be described.

In FIG. 5, time intervals of times t11, t12, t13, . . . , t18 represent micro frame units that generate one micro frame.

In a normal operation in which no error occurs, a light emission pulse having a predetermined light emission period in a micro frame unit and a predetermined modulation frequency is supplied from the distance measuring sensor 12 to the illumination device 11. The illumination device 11 emits irradiation light in synchronization with the light emission pulse. The distance measuring sensor 12 receives the reflected light of the irradiation light reflected by the object and outputs phase data. The phase data includes the detection signals of the phase of 0 degrees and the phase of 180 degrees or the detection signals of the phase of 90 degrees and the phase of 270 degrees. The minimum distance measuring data unit in which the depth value d to the object can be calculated is four micro frame units in a case of the 4-phase method.

In the example of FIG. 5, it is assumed that after the light emission and light reception operations are normally executed from the times t11 to t13, an error (LD error) occurs in the illumination device 11 at the time t21 after the time t13.

In this case, at the time t21, an error occurrence notification flag for making notification of the occurrence of an error of the illumination device 11 is set to High, and the illumination device 11 notifies the distance measuring sensor 12 of the LD error occurrence.

When the LD error occurrence is acquired, the LD error detecting unit 41 of the distance measuring sensor 12 controls the light emission timing control unit 32 to stop the output of the light emission pulse. Accordingly, the output of the light emission pulse is stopped at the portion depicted by the rectangle of the broken line in FIG. 5.

In addition, the LD error detecting unit 41 notifies the output IF 38 of the LD error. The output IF 38 outputs the distance measuring data, which is to be output, with an error flag added thereto, while the LD error is supplied from the LD error detecting unit 41. In FIG. 5, the phase data with the diagonal lines added indicates the phase data with the error flag added. The notification of the LD error supplied from the LD error detecting unit 41 to the output IF 38 can also be supplied by a High or Low signal, similarly to the error occurrence notification flag of FIG. 5.

Then, at the time t22 before the time t17 that is the start timing of the next distance measuring data unit, the LD error detecting unit 41 transmits a start command (LD start) to the illumination device 11. The error occurrence notification flag is cleared (changed to Low) by the start command, and the illumination device 11 is restarted to prepare for light emission such as a calibration operation (operation confirmation) of the light source performed before light emission. The time t22 is a time at which a time necessary for the light emission preparation is secured for the time t17 that is the start timing of the distance measuring data unit.

In addition, at the time t22, the LD error detecting unit 41 turns off the notification of the LD error to the output IF 38.

Then, the illumination device 11 returns to the normal operation after the time t17. That is, the light emission pulse is supplied from the distance measuring sensor 12 to the illumination device 11, and the illumination device 11 irradiates the object with irradiation light in synchronization with the light emission pulse. The distance measuring sensor 12 receives the reflected light of the irradiation light reflected by the object and outputs phase data.

### <5. Flowchart of LD Error Control Process>

### <First LD Error Control Process>

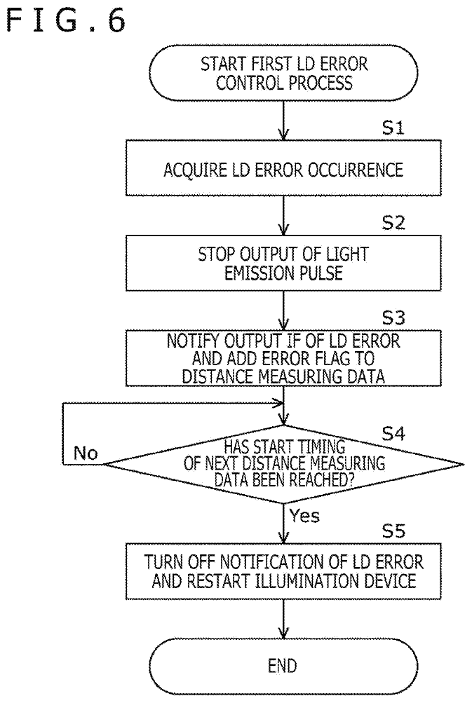

Next, a first LD error control process performed by the distance measuring sensor 12 will be described with reference to the flowchart of FIG. 6. This process is started, for example, when LD error occurrence indicating that an error has occurred is notified from the illumination device 11 to the distance measuring sensor 12.

First, in Step S1, the LD error detecting unit 41 acquires LD error occurrence supplied from the light emission control unit 51 of the illumination device 11 via the input/output terminals 53-1 and the 39-3.

In Step S2, the LD error detecting unit 41 controls the light emission timing control unit 32 to stop the output of the light emission pulse. The light emission timing control unit 32 stops the output of the light emission pulse to the illumination device 11.

In Step S3, the LD error detecting unit 41 notifies the output IF 38 of the LD error. The output IF 38 outputs the distance measuring data, which is to be output, with an error flag added thereto, while the LD error is supplied from the LD error detecting unit 41.

In Step S4, the LD error detecting unit 41 determines whether or not the start timing of the next distance measuring data unit has been reached, and waits until it is determined that the start timing of the next distance measuring data unit has been reached.

In a case where it is determined in Step S4 that the start timing of the next distance measuring data unit has been reached, the process proceeds to Step S5 where the LD error detecting unit 41 turns off the notification of the LD error to the output IF 38, transmits a start command (LD start) to the illumination device 11 via the input/output terminal 39-3, and restarts the illumination device 11.

In this way, the first LD error control process is terminated.

It should be noted that in Step S3 described above, the LD error detecting unit 41 notifies the output IF 38 of the LD error, and the output IF 38 outputs the distance measuring data with the error flag added thereto, while the LD error occurs. Accordingly, the host control unit 13 receiving the distance measuring data can recognize that the distance measuring data is inaccurate data due to the LD error. In a case where the signal format conforms to the MIPI standard, for example, the error flag can be stored in embedded data or the like and output. In addition to the above, the error flag may be added prior to or subsequent to the distance measuring data, and the format of the error flag can freely be selected.

In addition, the LD error detecting unit 41 may stop the output of the distance measuring data while the LD error occurs, instead of notifying the output IF 38 of the LD error and adding the error flag to the distance measuring data. In this case, the LD error detecting unit 41 controls the light emission timing control unit 32, the pixel control unit 34, and the like to stop the light reception operation of the pixel array section 25.

### <Second LD Error Control Process>

The above-described first LD error control process is a basic process of the LD error control executed by the distance measuring sensor 12. On the basis of the first LD error control process, the distance measuring sensor 12 can further add other functions to execute the process.

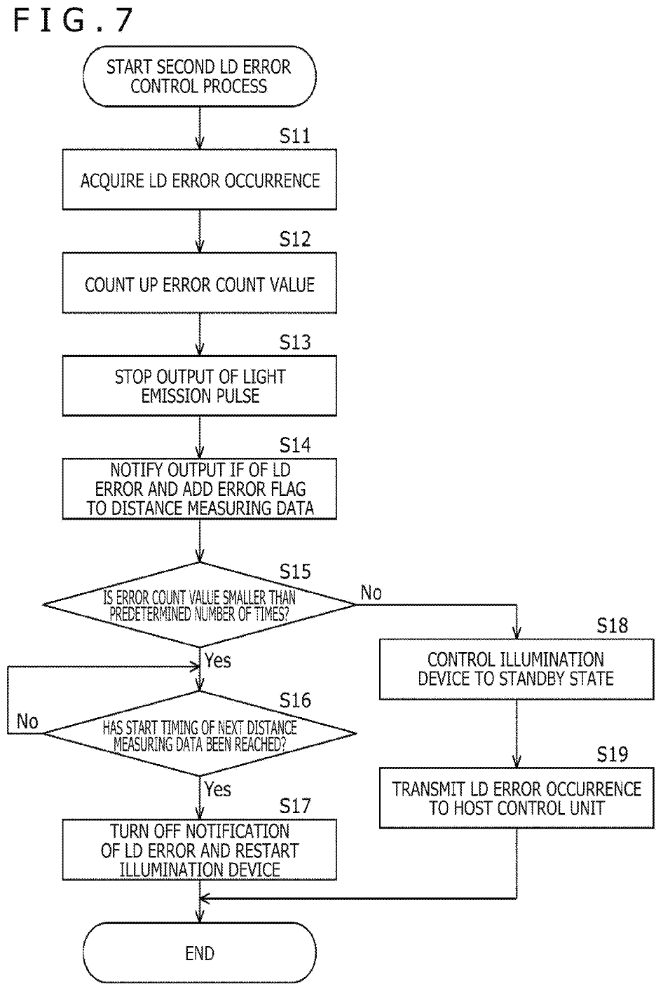

FIG. 7 depicts a flowchart of a second LD error control process.

In the second LD error control process, a function of counting the number of times of occurrence of LD errors and notifying the host control unit 13 in a case where LD errors the number of which is equal to or larger than a predetermined number of times have occurred is added to the first LD error control process.

Specifically, when the illumination device 11 notifies the distance measuring sensor 12 of the LD error occurrence, the LD error detecting unit 41 first acquires, in Step S11, the LD error occurrence supplied from the light emission control unit 51 of the illumination device 11.

Then, in Step S12, the LD error detecting unit 41 counts up an error count value, which counts the number of times of occurrence of LD errors, only by one.

In Step S13, the LD error detecting unit 41 controls the light emission timing control unit 32 to stop the output of the light emission pulse. The light emission timing control unit 32 stops the output of the light emission pulse to the illumination device 11.

In Step S14, the LD error detecting unit 41 notifies the output IF 38 of the LD error. The output IF 38 outputs the distance measuring data, which is to be output, with an error flag added thereto, while the LD error is supplied from the LD error detecting unit 41.

The processes of Steps S13 and S14 are similar to those of Steps S2 and S3 of the first LD error control process.

Then, in Step S15, the LD error detecting unit 41 determines whether or not the error count value is smaller than the predetermined number of times set as a threshold value, and in a case where it is determined to be smaller, the process proceeds to Step S16. The processes of Step S16 and the next Step S17 are similar to those of Steps S4 and S5 of the first LD error control process, and thus the description thereof will be omitted.

On the other hand, in a case where it is determined in Step S15 that the error count value is equal to or larger than the predetermined number of times, the process proceeds to Step S18 where the LD error detecting unit 41 transmits a stop command (LD stop) to the illumination device 11 via the input/output terminals 53-1 and 39-3, and controls the illumination device 11 to a standby state. The standby state is, for example, a state in which only the communication function with the outside is operating.

Then, in Step S19, the LD error detecting unit 41 transmits the LD error occurrence to the host control unit 13, and terminates the second LD error control process.

According to the second LD error control process, the distance measuring sensor 12 detects a case in which the LD errors the number of which is equal to or larger than the predetermined number of times have occurred, so that the distance measuring sensor 12 determines that the error is not caused by disturbance but a failure, and notifies the host control unit 13 of the LD error occurrence.

For example, the host control unit 13 notified of the LD error occurrence displays an error message such as “the illumination of the distance measuring sensor has failed” or “restart the device” on the display, and notifies a user of the occurrence of the LD error.

### <Third LD Error Control Process>

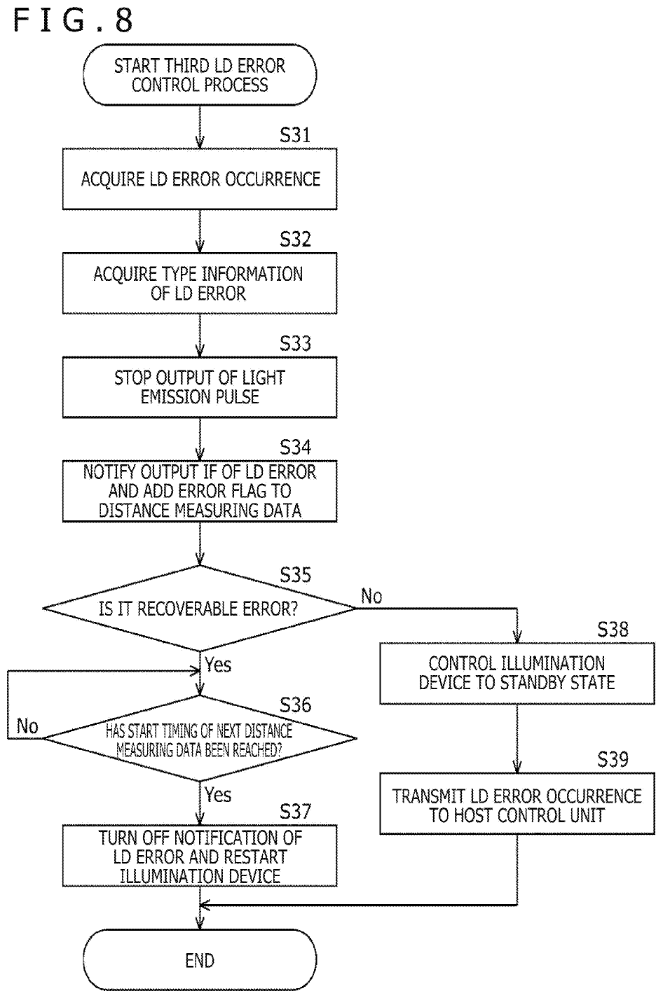

FIG. 8 depicts a flowchart of a third LD error control process.

In the third LD error control process, the illumination device 11 has a function of making notification of the type of LD error, and a function of acquiring the type information of the LD error and performing control according to the type information by the distance measuring sensor 12 is added to the first LD error control process.

Specifically, when the illumination device 11 notifies the distance measuring sensor 12 of the LD error occurrence, the LD error detecting unit 41 first acquires, in Step S31, the LD error occurrence supplied from the light emission control unit 51 of the illumination device 11.

Then, in Step S32, the LD error detecting unit 41 acquires the type information of the LD error via the input/output terminals 53-1 and 39-3. For example, the register corresponding to the type information of the LD error is read using a serial communication such as the SPI or the I2C to acquire the type information of the LD error.

In Step S33, the LD error detecting unit 41 controls the light emission timing control unit 32 to stop the output of the light emission pulse. The light emission timing control unit 32 stops the output of the light emission pulse to the illumination device 11.

In Step S34, the LD error detecting unit 41 notifies the output IF 38 of the LD error. The output IF 38 outputs the distance measuring data, which is to be output, with an error flag added thereto, while the LD error is supplied from the LD error detecting unit 41.

The processes of Steps S33 and S34 are similar to those of Steps S2 and S3 of the first LD error control process.

Then, in Step S35, the LD error detecting unit 41 determines whether or not the LD error is a recoverable error, on the basis of the acquired type information of the LD error.

In a case where it is determined in Step S35 that the LD error is a recoverable error, the process proceeds to Step S36. The processes of Step S36 and the next Step S37 are similar to those of Steps S4 and S5 of the first LD error control process, and thus the description thereof will be omitted.

On the other hand, in a case where it is determined in Step S35 that the LD error is not a recoverable error, the process proceeds to Step S38. The processes of Step S38 and the next Step S39 are similar to those of Steps S18 and S19 of the second LD error control process, and thus the description thereof will be omitted.

For example, the host control unit 13 notified of the LD error occurrence displays an error message such as “the illumination of the distance measuring sensor has failed” or “restart the device” on the display, and notifies the user of the occurrence of the LD error.

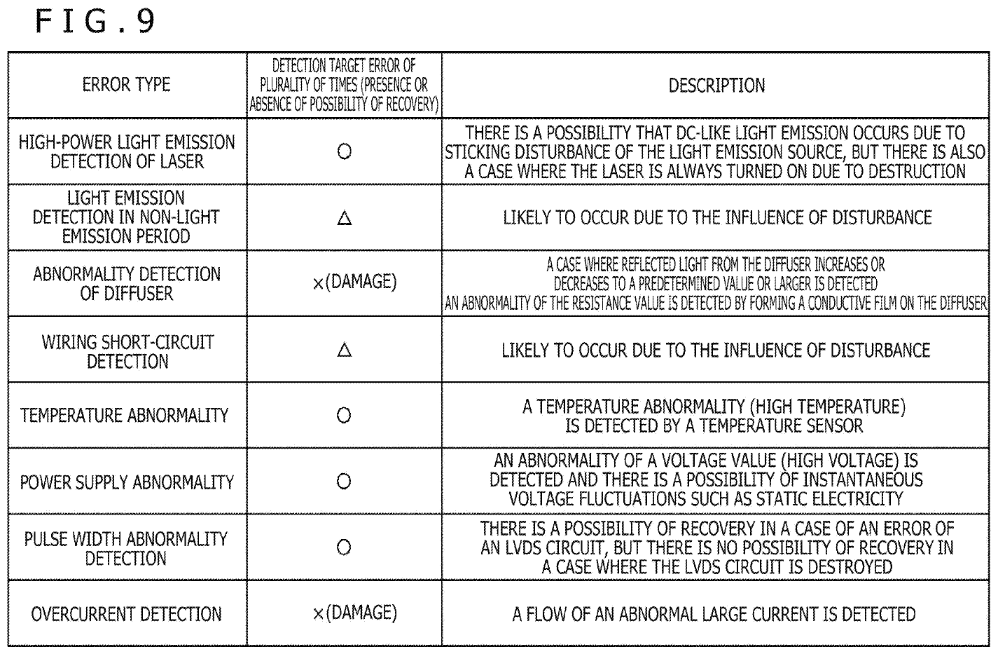

FIG. 9 depicts an example of a table for determining the type information of the LD error that can be acquired in Step S32 described above and whether or not the LD error is a recoverable error.

The types of LD errors include, for example, as depicted in FIG. 9, high-power light emission detection of a laser, light emission detection in a non-light emission period, abnormality detection of a diffuser, wiring short-circuit detection, a temperature abnormality, a power supply abnormality, pulse width abnormality detection, overcurrent detection, and the like.

In the high-power light emission detection of the laser, there is a possibility that DC-like light emission occurs due to the sticking disturbance of the light emission source 52, and in that case, there is a possibility of recovery. However, there is also a case where the laser is always ON due to destruction and the possibility of recovery is low in that case.

Since the light emission detection in the non-light emission period can occur due to the influence of the disturbance, there is a possibility of recovery.

In the abnormality detection of the diffuser, a case where reflected light from the diffuser increases or decreases to a predetermined value or larger or an abnormality of the resistance value is detected by forming a conductive film on the diffuser, but the abnormality is caused by damage in many cases and the possibility of recovery is low.

The wiring short-circuit detection depends on a detection method, but the short-circuit is possibly caused by the influence of disturbance, and thus there is a possibility of recovery.

In a case of a temperature abnormality, a temperature abnormality (high temperature) is detected by a temperature sensor, and there is a possibility of recovery.

In a case of the power supply abnormality, instantaneous voltage fluctuations such as an abnormality of a voltage value (high voltage) and static electricity are detected, but there is a possibility of recovery.

In the pulse width abnormality detection, there is a possibility of recovery in a case of an error of an LVDS (Low Voltage Differential Signaling) circuit, but the possibility of recovery is low in a case where the LVDS circuit is destroyed.

In the overcurrent detection, a flow of an abnormal large current is detected and damage is assumed to occur, and thus the possibility of recovery is low.

The LD error detecting unit 41 refers to the table information of FIG. 9 stored in the internal memory, and determines whether or not the acquired LD error is a recoverable error. Then, in a case where it is determined that the LD error is not a recoverable error, the LD error detecting unit 41 notifies the host control unit 13 of the occurrence of the unrecoverable error.

It is possible to employ a serial communication in which, with emphasis on immediacy, a control terminal is connected for the occurrence of the LD error and in which a large amount of information can be exchanged with a small number of terminals for the type of error.

### <Fourth LD Error Control Process>

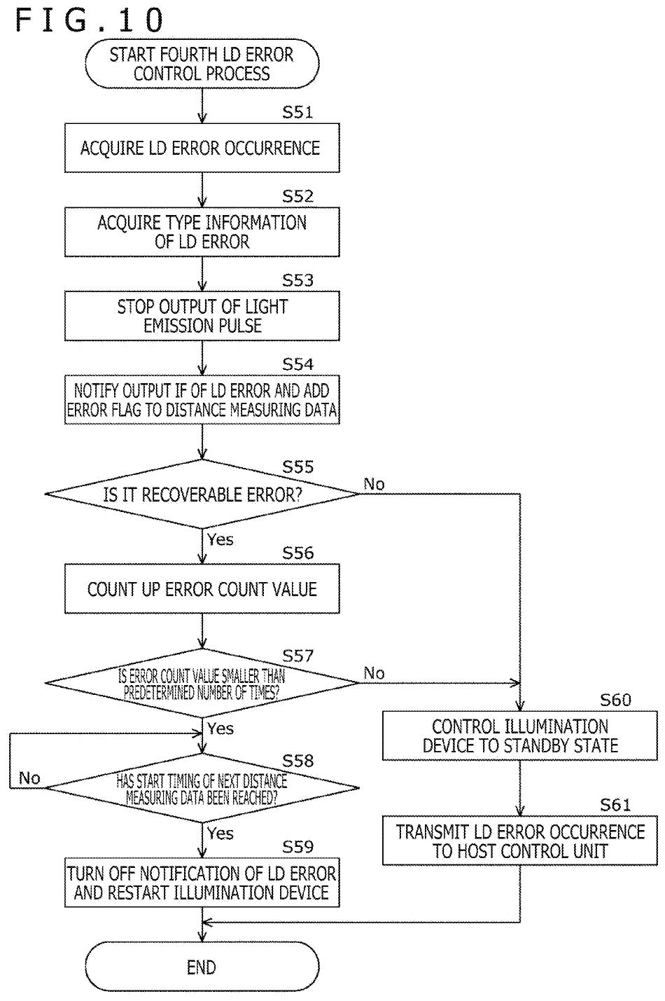

FIG. 10 depicts a flowchart of a fourth LD error control process.

The fourth LD error control process has the functions of the second LD error control process and the third LD error control process described above. That is, a function in which the distance measuring sensor 12 acquires the type information of the LD error from the illumination device 11, counts the number of times of occurrence of the LD errors in a case where a recoverable error occurs, performs restart until the predetermined number of times is reached, and immediately notifies the host control unit 13 in a case where an unrecoverable error occurs is added to the first LD error control process.

Specifically, when the illumination device 11 notifies the distance measuring sensor 12 of the LD error occurrence, the LD error detecting unit 41 first acquires, in Step S51, the LD error occurrence supplied from the light emission control unit 51 of the illumination device 11.

Then, in Step S52, the LD error detecting unit 41 reads a register to acquire the type information of the LD error.

In Step S53, the LD error detecting unit 41 controls the light emission timing control unit 32 to stop the output of the light emission pulse. The light emission timing control unit 32 stops the output of the light emission pulse to the illumination device 11.

In Step S54, the LD error detecting unit 41 notifies the output IF 38 of the LD error. The output IF 38 outputs the distance measuring data, which is to be output, with an error flag added thereto, while the LD error is supplied from the LD error detecting unit 41.

Then, in Step S55, the LD error detecting unit 41 determines whether or not the LD error is a recoverable error, on the basis of the acquired type information of the LD error.

In a case where it is determined in Step S55 that the LD error is a recoverable error, the process proceeds to Step S56.

In Step S56, the LD error detecting unit 41 counts up the error count value, which counts the number of times of occurrence of LD errors, only by one.

Then, in Step S57, the LD error detecting unit 41 determines whether the error count value is smaller than the predetermined number of times set as a threshold value, and in a case where it is determined to be smaller, the process proceeds to Step S58. The processes of Step S58 and the next Step S59 are similar to those of Steps S4 and S5 of the first LD error control process, and thus the description thereof will be omitted.

On the other hand, in a case where it is determined in Step S55 that the LD error is not a recoverable error, or in a case where it is determined in Step S57 that the error count value is equal to or larger than the predetermined number of times, the process proceeds to Step S60 where the LD error detecting unit 41 transmits a stop command (LD stop) to the illumination device 11 and controls the illumination device 11 to a standby state.

Then, in Step S61, the LD error detecting unit 41 transmits the LD error occurrence to the host control unit 13, and terminates the fourth LD error control process.

In the second to fourth LD error control processes described above, the output of the distance measuring data may be stopped instead of outputting the distance measuring data with the error flag added thereto, which is similar to the first LD error control process.

According to the above-described first to fourth LD error control processes, the distance measuring sensor 12 detects an error (LD error) occurring in the illumination device 11, stops the light emission pulse, and restarts the illumination device 11. Accordingly, it is possible to quickly cope with the error of the illumination device 11. In addition, in response to the error of the illumination device 11, the distance measuring sensor 12 adds the error flag to the distance measuring data, stops the light reception operation (exposure operation), and resumes, according to the restart timing, the output of the light emission pulse. According to the distance measuring system 1, since the control of the restart of the illumination device 11 and the light reception operation of the distance measuring sensor 12 can be performed without the control of the host control unit 13, the stand-alone control by the distance measuring system 1 alone can be performed.

### <6. Chip Configuration Example of Distance Measuring Sensor>

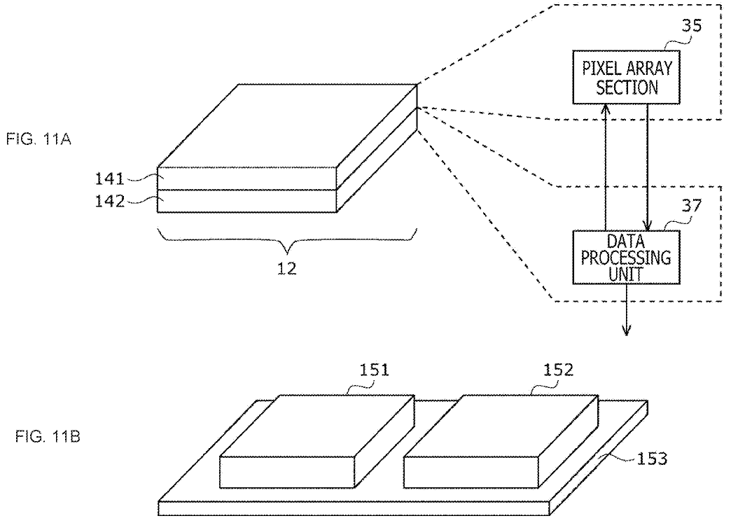

FIG. 11 is a perspective view depicting a chip configuration example of the distance measuring sensor 12.

As depicted in A of FIG. 11, the distance measuring sensor 12 can include one chip obtained by laminating a first die (substrate) 141 and a second die (substrate) 142.

For example, at least the pixel array section 35 as a light reception section is arranged in the first die 141, and, for example, the data processing unit 37 for performing a process for generating a depth frame and a depth map with use of a detection signal output from the pixel array section 35, and the like are arranged in the second die 142.

It should be noted that in addition to the first die 141 and the second die 142, the distance measuring sensor 12 may include three layers obtained by laminating another logic die, or may be configured by laminating four or more layers of dies (substrates).

In addition, part of functions of the distance measuring sensor 12 may be performed by a signal processing chip different from the distance measuring sensor 12. For example, as depicted in B of FIG. 11, a sensor chip 151 as the distance measuring sensor 12 and a logic chip 152 for performing signal processing at a subsequent stage can be formed on a relay substrate 153. The logic chip 152 can be configured to perform part of the above-described process performed by the data processing unit 37 of the distance measuring sensor 12, for example, the process for generating a depth frame and a depth map.

<7. Comparison with Another Light Emission Control Method>

The above-described distance measuring system 1 is configured in such a manner that the distance measuring sensor 12 detects an error (LD error) occurring in the illumination device 11 and controls to restart the illumination device 11.

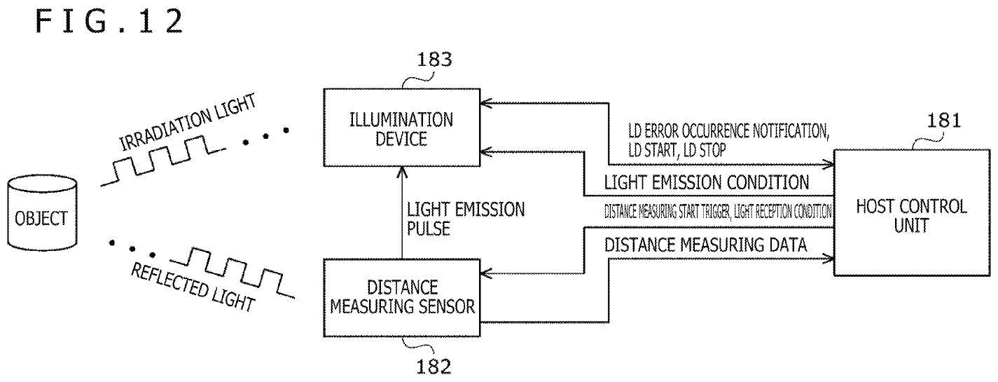

In contrast, as depicted in FIG. 12, there is also a method in which a host control unit 181 manages an error of an illumination device 183.

FIG. 12 depicts a configuration example of another distance measuring system as a comparison example, and this distance measuring system includes a host control unit 181, a distance measuring sensor 182, and an illumination device 183.

The host control unit 181 supplies light emission conditions to the illumination device 183, and supplies light reception conditions corresponding to the light emission conditions to the distance measuring sensor 182.

Then, the host control unit 181 supplies a distance measuring start trigger to the distance measuring sensor 182, and the distance measuring sensor 182 supplies a light emission pulse generated according to the distance measuring start trigger to the illumination device 183 to cause the illumination device 183 to emit light. In a case where an error occurs in the illumination device 183, the illumination device 183 notifies the host control unit 181 of the LD error occurrence, and the host control unit 181 controls to restart the illumination device 183.

In such a control method, in a case where an error occurs in the illumination device 183, the distance measuring sensor 182 does not recognize that an error has occurred in the illumination device 183, so that the distance measuring sensor 182 continues to output a light emission pulse, and there is a possibility that the timing for restarting the illumination device 183 cannot be taken or the illumination device 183 malfunctions. In order to safely restart, it is necessary to temporarily stop the distance measuring sensor 182, and it takes time to restart both the distance measuring sensor 182 and the illumination device 183. Although the host control unit 181 can control the distance measuring sensor 182 by managing the timing of the restart, the load on the host control unit 181 becomes large, and the stand-alone control by the distance measuring system 1 alone is impossible.

On the other hand, in the distance measuring system 1 of FIG. 1, since the distance measuring sensor 12 manages the error of the illumination device 11 and controls the output stop and the output resume of the light emission pulse by itself, it is possible to perform the stand-alone control without requiring the control of the host control unit 13.

In addition, for example, since it is possible to perform control in synchronization with the operation of the distance measuring sensor 12 itself without stopping the operation of the distance measuring sensor 12, the control including, for example, control of the timing so as to be able to resume from the distance measuring data unit, it is possible to recover (restart) at an early stage without causing both the distance measuring sensor 12 and the illumination device 11 to malfunction. By reducing the load on the host control unit 13, it is possible to contribute to the low power consumption of the entire host device in which the distance measuring system 1 is incorporated.

The above-described LD error control by the distance measuring system 1 is not only applied to the distance measuring system of the indirect ToF method, but can be applied to a distance measuring system of the structured light method or the direct ToF.

### <8. Example of Application to Electronic Equipment>

For example, the above-described distance measuring system 1 can be mounted on electronic equipment such as a smartphone, a tablet type terminal, a cellular phone, a personal computer, a game machine, a television receiver, a wearable terminal, a digital still camera, and a digital video camera.

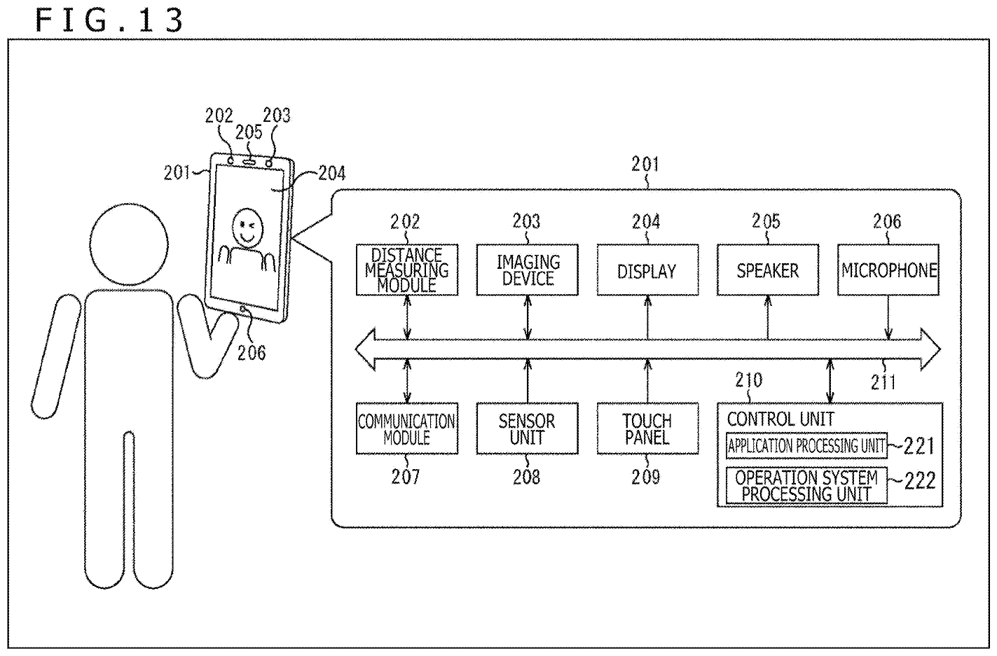

FIG. 13 is a block diagram depicting a configuration example of a smartphone as electronic equipment on which the distance measuring system 1 is mounted.

As depicted in FIG. 13, a smartphone 201 is configured in such a manner that a distance measuring module 202, an imaging device 203, a display 204, a speaker 205, a microphone 206, a communication module 207, a sensor unit 208, a touch panel 209, and a control unit 210 are connected to each other via a bus 211. In addition, in the control unit 210, a CPU executes programs to provide functions as an application processing unit 221 and an operation system processing unit 222.

The distance measuring system 1 of FIG. 1 is applied to the distance measuring module 202. For example, the distance measuring module 202 is arranged on the front surface of the smartphone 201, and by performing distance measuring for the user of the smartphone 201, the depth value of the surface shape of a face, a hand, a finger, or the like of the user can be output as a distance measuring result. The host control unit 13 of FIG. 1 corresponds to the control unit 210 of FIG. 13.

The imaging device 203 is arranged on the front surface of the smartphone 201, and images, as the subject, the user of the smartphone 201 to acquire an image in which the user is photographed. It should be noted that although not illustrated, the imaging device 203 may also be arranged on the back surface of the smartphone 201.

The display 204 displays an operation screen for performing a process by the application processing unit 221 and the operation system processing unit 222, an image imaged by the imaging device 203, and the like. For example, when a phone call is made by the smartphone 201, the speaker 205 and the microphone 206 output the voice of the opposite party and collect the voice of the user.

The communication module 207 performs communications via a communication network. The sensor unit 208 senses a speed, an acceleration, proximity, and the like, and the touch panel 209 acquires a touch operation performed by the user on the operation screen displayed on the display 204.

The application processing unit 221 performs a process for providing various services by the smartphone 201. For example, on the basis of the depth map supplied from the distance measuring module 202, the application processing unit 221 can perform a process for creating a face by computer graphics that virtually reproduces the facial expression of the user and displaying the face on the display 204. In addition, on the basis of the depth map supplied from the distance measuring module 202, the application processing unit 221 can perform a process for, for example, creating three-dimensional shape data of a given stereoscopic object.

The operation system processing unit 222 performs a process for realizing the basic functions and operations of the smartphone 201. For example, on the basis of the depth map supplied from the distance measuring module 202, the operation system processing unit 222 can perform a process for authenticating the face of the user and unlocking the smartphone 201. In addition, on the basis of the depth map supplied from the distance measuring module 202, the operation system processing unit 222 can perform a process for, for example, recognizing a gesture of the user and inputting various operations according to the gesture.

By applying the above-described distance measuring system 1 to the smartphone 201 configured in such a manner as described above, even in a case where an error occurs in the illumination device 11 of the distance measuring module 202 (distance measuring system 1), it is possible to quickly cope with the error. In addition, since the power consumption of the distance measuring module 202 can be reduced and the load on the control unit 210 can also be lightened, the power consumption of the entire smartphone 201 can also be reduced.

### <9. Example of Application to Mobile Body>

The technology according to the present disclosure (the present technology) can be applied to various products. For example, the technology according to the present disclosure may be realized as a device mounted on any type of mobile body, such as an automobile, an electric vehicle, a hybrid electric vehicle, a motorcycle, a bicycle, a personal mobility, an airplane, a drone, a ship, and a robot.

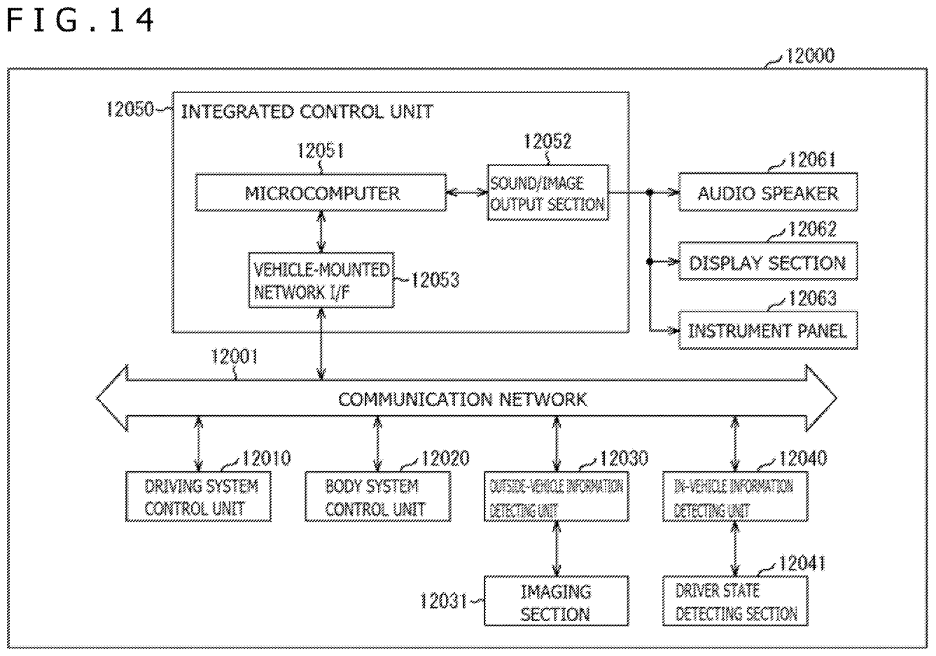

FIG. 14 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 14, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 14, an audio speaker 12061, a display section 12062, and an instrument panel 12063 are illustrated as the output device. The display section 12062 may, for example, include at least one of an on-board display and a head-up display.

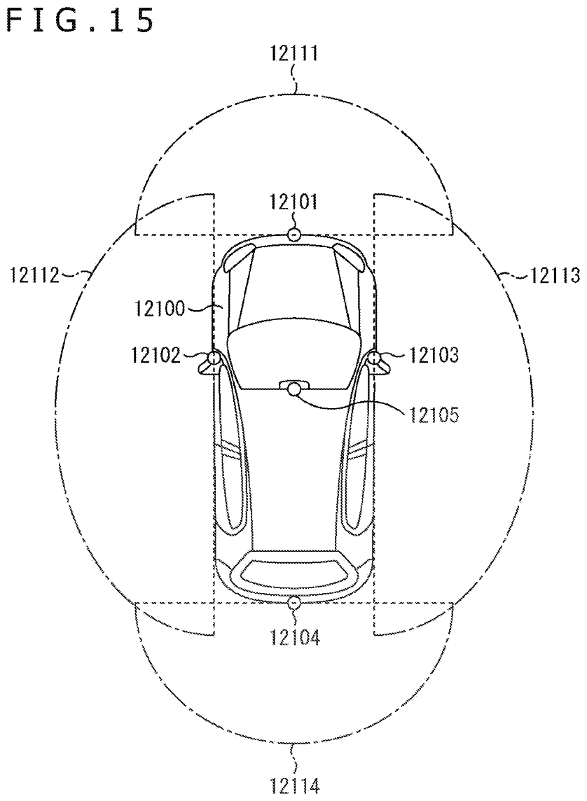

FIG. 15 is a diagram depicting an example of the installation position of the imaging section 12031.

In FIG. 15, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 15 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the outside-vehicle information detecting unit 12030 and the in-vehicle information detecting unit 12040 among the configurations described above. Specifically, by using the distance measuring by the distance measuring system 1 as the outside-vehicle information detecting unit 12030 and the in-vehicle information detecting unit 12040, a process for recognizing a gesture of the driver is performed, and various (for example, an audio system, a navigation system, and an air conditioning system) operations according to the gesture can be executed, or the state of the driver can be more accurately detected. In addition, the distance measuring by the distance measuring system 1 can be used to recognize the unevenness of the road surface and reflect the unevenness in the control of the suspension. In addition, even in a case where an error occurs in the illumination device 11 of the distance measuring system 1, it is possible to quickly cope with the error.

The embodiment of the present technology is not limited to that described above, and can be variously changed without departing from the gist of the present technology.

A plurality of the present technologies described in the specification can be independently carried out as long as no conflict occurs. It is obvious that a plurality of the present technologies which are freely selected can be carried out in combination. In addition, some or all of the above-described plurality of the present technologies which are freely selected can be carried out in combination with other technologies that are not described above.

In addition, for example, the configuration described as one device (or a processing unit) is divided and may be configured as a plurality of devices (or processing units). Conversely, the configurations described above as a plurality of devices (or processing units) may be collectively configured as one device (or a processing unit). In addition, it is also possible to add a configuration other than those described above to the configuration of each device (or each processing unit). Further, if the configuration and operation as the entire system are substantially the same, part of the configuration of one device (or one processing unit) may be included in the configuration of another device (or another processing unit).

Further, in the specification, the system means a set of a plurality of constitutional elements (devices, modules (parts), and the like), and whether or not all the constitutional elements are in the same housing is not considered. Therefore, a plurality of devices housed in separate housings and connected to each other via a network and one device in which a plurality of modules is housed in one housing are both systems.

It should be noted that the effects described in the specification are merely illustrative and not limited thereto, and effects other than those described in the specification may be provided.

It should be noted that the present technology can have the following configurations.

(1)

A distance measuring sensor including:

a pixel array section in which pixels that receive reflected light returned after irradiation light applied from an illumination device is reflected by an object and that output detection signals according to an amount of received light are two dimensionally arranged; and

a control unit that detects occurrence of an error of the illumination device and performs control according to the error.

(2)

The distance measuring sensor according to (1),

in which, in a case where occurrence of an error of the illumination device is detected, the control unit stops output of a light emission pulse to the illumination device.

(3)

The distance measuring sensor according to (1) or (2),

in which, in a case where occurrence of an error of the illumination device is detected, the control unit restarts the illumination device.

(4)

The distance measuring sensor according to (3),

in which, in a case where occurrence of an error of the illumination device is detected, the control unit restarts the illumination device at a start timing of a distance measuring data unit.

(5)

The distance measuring sensor according to any one of (1) to (4),

in which, in a case where occurrence of an error of the illumination device is detected, the control unit stops output of distance measuring data.

(6)

The distance measuring sensor according to any one of (1) to (5),

in which, in a case where occurrence of an error of the illumination device is detected, the control unit outputs distance measuring data with an error flag added thereto.

(7)

The distance measuring sensor according to any one of (1) to (6),

in which the control unit counts the number of times of occurrence of errors and, in a case where the number of times of occurrence of errors is equal to or larger than a predetermined number of times, notifies a higher-level host control unit of the occurrence of the error of the illumination device.

(8)

The distance measuring sensor according to any one of (1) to (7),

in which, in a case where occurrence of an error of the illumination device is detected, the control unit acquires type information of the error of the illumination device and performs control according to the type information.

(9)

The distance measuring sensor according to (8),

in which, in a case where the type information indicates a predetermined error, the control unit notifies a higher-level host control unit of occurrence of the error of the illumination device.

(10)

The distance measuring sensor according to (8) or (9),

in which, in a case where the type information indicates a predetermined error, the control unit counts the number of times of occurrence of errors and, in a case where the number of times of occurrence of errors is equal to or larger than a predetermined number of times, notifies a higher-level host control unit of the occurrence of the error of the illumination device.

(11)

A distance measuring system including:

an illumination device that irradiates an object with irradiation light; and

a distance measuring sensor that receives reflected light returned after the irradiation light is reflected by the object,

in which the distance measuring sensor includes
a pixel array section in which pixels outputting detection signals according to an amount of the received reflected light are two dimensionally arranged, and
a control unit that detects occurrence of an error of the illumination device and performs control according to the error.
   (12)

Electronic equipment including:

a distance measuring system including
an illumination device that irradiates an object with irradiation light, and
a distance measuring sensor that receives reflected light returned after the irradiation light is reflected by the object,
the distance measuring sensor including
   a pixel array section in which pixels outputting detection signals according to an amount of the received reflected light are two dimensionally arranged, and
   a control unit that detects occurrence of an error of the illumination device and performs control according to the error.

### REFERENCE SIGNS LIST

1: Distance measuring system
11: Illumination device
12: Distance measuring sensor
13: Host control unit
31: Control unit
32: Light emission timing control unit
35: Pixel array section
37: Data processing unit
38: Output IF
41: LD error detecting unit
51: Light emission control unit
52: Light emission source
201: Smartphone
202: Distance measuring module

1. A distance measuring sensor comprising:
a pixel array section in which pixels that receive reflected light returned after irradiation light applied from an illumination device is reflected by an object and that output detection signals according to an amount of received light are two dimensionally arranged; and
a control unit that detects occurrence of an error of the illumination device and performs control according to the error.

2. The distance measuring sensor according to claim 1,
wherein, in a case where occurrence of an error of the illumination device is detected, the control unit stops output of a light emission pulse to the illumination device.

3. The distance measuring sensor according to claim 1,
wherein, in a case where occurrence of an error of the illumination device is detected, the control unit restarts the illumination device.

4. The distance measuring sensor according to claim 3,
wherein, in a case where occurrence of an error of the illumination device is detected, the control unit restarts the illumination device at a start timing of a distance measuring data unit.

5. The distance measuring sensor according to claim 1,
wherein, in a case where occurrence of an error of the illumination device is detected, the control unit stops output of distance measuring data.

6. The distance measuring sensor according to claim 1,
wherein, in a case where occurrence of an error of the illumination device is detected, the control unit outputs distance measuring data with an error flag added thereto.

7. The distance measuring sensor according to claim 1,
wherein the control unit counts the number of times of occurrence of errors and, in a case where the number of times of occurrence of errors is equal to or larger than a predetermined number of times, notifies a higher-level host control unit of the occurrence of the error of the illumination device.

8. The distance measuring sensor according to claim 1,
wherein, in a case where occurrence of an error of the illumination device is detected, the control unit acquires type information of the error of the illumination device and performs control according to the type information.

9. The distance measuring sensor according to claim 8,
wherein, in a case where the type information indicates a predetermined error, the control unit notifies a higher-level host control unit of occurrence of the error of the illumination device.

10. The distance measuring sensor according to claim 8,
wherein, in a case where the type information indicates a predetermined error, the control unit counts the number of times of occurrence of errors and, in a case where the number of times of occurrence of errors is equal to or larger than a predetermined number of times, notifies a higher-level host control unit of the occurrence of the error of the illumination device.

11. A distance measuring system comprising:
an illumination device that irradiates an object with irradiation light; and
a distance measuring sensor that receives reflected light returned after the irradiation light is reflected by the object,
wherein the distance measuring sensor includes
a pixel array section in which pixels outputting detection signals according to an amount of the received reflected light are two dimensionally arranged, and
a control unit that detects occurrence of an error of the illumination device and performs control according to the error.

12. Electronic equipment comprising:
a distance measuring system including
an illumination device that irradiates an object with irradiation light, and
a distance measuring sensor that receives reflected light returned after the irradiation light is reflected by the object,
the distance measuring sensor including
a pixel array section in which pixels outputting detection signals according to an amount of the received reflected light are two dimensionally arranged, and
a control unit that detects occurrence of an error of the illumination device and performs control according to the error.
